(19) United States
(12) Patent Application Publication
(10) Pub. No.: US 2011/0219427 A1
(43) Pub. Date: Sep. 8, 2011

(54) Smart Device User Authentication

(75) Inventors: Gent Hito, Chapel Hill, NC (US); Tomas Restrepo Madrid, Medellin (CO)

(73) Assignee: RSSBus, Inc., Chapel Hill (US)

(21) Appl. No.: 13/036,497

(22) Filed: Feb. 28, 2011

Related U.S. Application Data
(60) Provisional application No. 61/310,592, filed on Mar. 4, 2010.

(51) Int. Cl. G06F 21/00

(52) U.S. Cl. 726/3

(57) ABSTRACT

Techniques for simplifying an authentication process from the viewpoint of a user while providing improved security to the many users currently employing no or weak security techniques. In logging into a web site hosted by a web server, a session begins by a user connecting and logging in with a device, such as a personal computer. Rather than a user name and password approach which is presently typical, the personal computer communicates with another user device, such as a smart phone. In one approach, an encoded acoustic signal is employed for this communication. The smart phone securely communicates with an authentication server which informs the web server whether the user has been authenticated or not.

The present application claims the benefit of U.S. Provisional Application No. 61/310,592 filed Mar. 4, 2010 which is incorporated herein by reference.

### FIELD OF THE INVENTION

The present invention relates generally to improved techniques for simplifying the process of user authentication or verification. More particularly, the invention relates to approaches for using a smart phone, personal digital assistant or the like to simplify the authentication process from the viewpoint of a user while providing improved security to the many users currently employing no or weak security techniques.

### BACKGROUND OF THE INVENTION

With more and more transactions being conducted over the Internet and the sophistication of people conducting those transactions potentially going down as ease of use and general acceptance of the security of the commercial framework increases, the need for appropriate security measures to counter hackers and Internet criminals remains critical. A large class of purchasers either unwilling or unable to remember and use a complicated password is regularly conducting more and more transactions. As a further example, many adults use the same simple password over and over so that their repeated transactions are more susceptible to hacking than desirable. Additionally, more and more transactions are conducted wirelessly in hot spots or using public computing devices or kiosks where security may be low if care is not employed to encrypt communication or take steps many consumers appear unwilling to take. Other examples could of course be added to this exemplary short list of security concerns.

### SUMMARY OF THE INVENTION

Among its several aspects, the present invention recognizes a need in many contexts for providing improved security with little or no burden to users. To such ends, one aspect of the present invention provides authentication or verification utilizing a user's first device, such as a smart phone, a smart watch, personal digital assistant (PDA) or the like to respond to an acoustic signal, a visual display, such as a bar code, text, a picture, a sequence thereof, or the like produced by a second device, such as a personal computer, laptop, kiosk, vending machine or the like requiring authentication or verification of the user to conduct a session or transaction utilizing the second device to access a web site running on a web server. The first device may advantageously communicate over a separate channel with an authentication server which contacts the web server which is in communication with the second device to confirm or deny the user's bona fides.

In a simple embodiment, the process is essentially effortless from the perspective of the user who simply must have a first device such as a suitably programmed smart phone within audible or visible range of the second device which is to be employed for the web session. In more sophisticated implementations, the user may be authenticated by the smart phone or other devices as addressed further below.

A more complete understanding of the present invention, as well as other features and advantages of the invention, will be apparent from the following detailed description, the accompanying drawings, and the claims.

### BRIEF DESCRIPTION OF THE DRAWINGS

FIG. 1 shows a block diagram of a system in accordance with a first embodiment of the invention;

FIG. 2 shows a flowchart of a process of user authentication in accordance with the present invention;

FIG. 3 shows a system in accordance with a further embodiment of the invention;

FIG. 4 illustrates aspects of an authentication process in accordance with the present invention; and

FIG. 5 illustrates an exemplary device provisioning process in accordance with the present invention.

### DETAILED DESCRIPTION

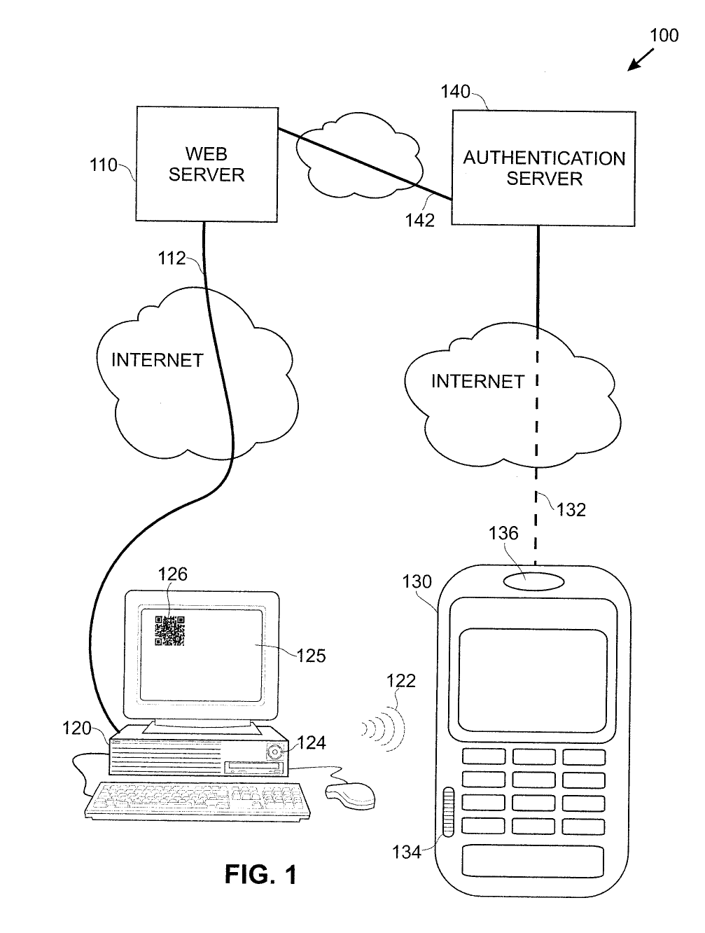

FIG. 1 shows a first embodiment of a system 100 in accordance with the present invention. In system 100, a web server 110 is shown connected to a personal computer 120 by a first Internet connection 112. The personal computer 120 in turn communicates with a user's smart phone 130. As illustrated in FIG. 1, this communication is made employing an acoustic signal 122. The acoustic signal 122 may be suitably produced by a speaker 124 of the personal computer 120 and picked up by a microphone 134 on the smart phone. The smart phone 130 is in turn communicating with an authentication server 140 utilizing a second Internet connection 132. The dashes in connection 132 of FIG. 1 indicate a wireless communication path or paths and the solid portion represents a wired link. Finally, the authentication server 140 communicates with the web server 110 utilizing a connection 142.

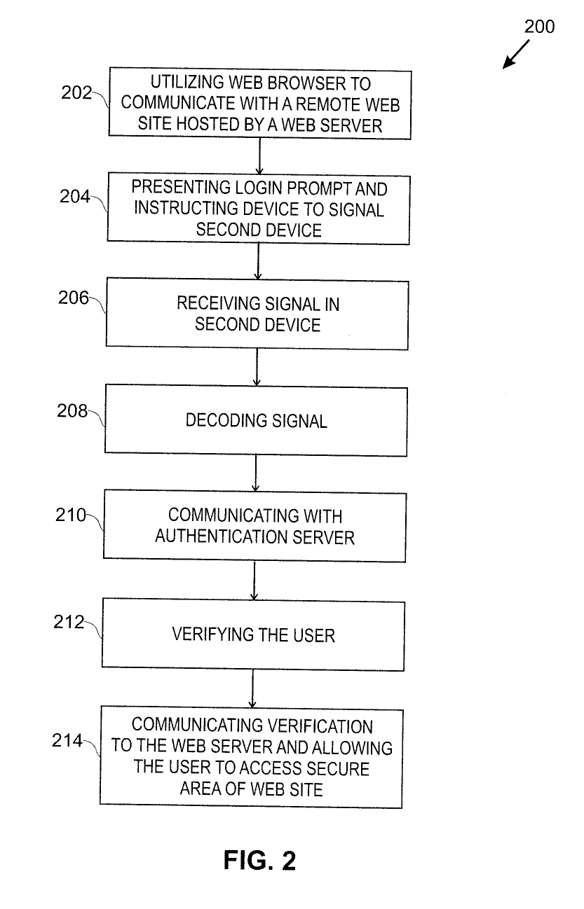

FIG. 2 shows a flowchart of a process 200 in accordance with the present invention. In step 202, a user attempts to visit a secure area of a web site hosted by a web server, such as web server 110. A secure area of the web site requires authentication. Log in begins by the user using a web browser on the personal computer 120 to communicate with the web site over a connection, such as first Internet connection 112. As one example of a typical web transaction of this nature, the user may be seeking to access his or her bank accounts and to conduct an online banking transaction, such as paying a bill, transferring funds or the like.

In step 204, the web site presents a login prompt that contains information about the attempted connection. For example, a display, such as display 125 of personal computer 120, may prompt the user to enter a user name and password, personal identification number (PIN) or the like. Substantially simultaneously, the web site instructs the personal computer 120 through the web server 110 to produce a QR code 126, an output or signal, for example, emitting an acoustic signal, such as the acoustic signal 122 of FIG. 1, that is detectable by the smart phone 130. Alternatively, the display 125 may be used to produce a bar code, text, a picture, a sequence thereof, or the like which is then detected using a camera, such as camera 136 of smart phone 130.

In step 206, the smart phone 130 may automatically recognize the acoustic signal 122 using a software process running in the background. Alternatively, the user may have to activate an application on the phone by selecting an icon, from a menu of applications or the like. In this latter case, selection of the application by the user could be cued by the acoustic signal, or might be cued by display of a web page instructing the user to activate the application for phone authentication.

In one embodiment, the acoustic signal will contain encoded information, such as a onetime unique identifier for the session, a unique session identifier or id, and the address for the web server 110 hosting the web site of interest to the user.

In step 208, the phone 130 decodes the acoustic signal 122 and determines the address of the web server 110 and the unique session id.

In step 210, the unique session id is communicated to an authentication server, such as the authentication server 140. For example, the signal id will be packaged in a network packet and transmitted over the second Internet connection 132 to authentication server 140. In a presently preferred embodiment, the unique session id will be cryptographically signed utilizing a private key, such as a digital certificate, stored in the smart phone 130.

In step 212, the authentication server 140 verifies the digital signature, thus verifying the smart phone storing that signature is within a predetermined distance of the personal computer 120 and by implication that the owner of the phone is present at the personal computer 120 and not some imposter.

In step 214, the authentication server communicates the verification to the web server 110. Upon positive verification, the web site accepts the user, the web server 110 sends a message to the web browser of personal computer 120 through the first Internet connection 112, and the login request is automatically removed from the display and the session commences with the user being given access to a secure area.

From the user's perspective, the entire process is almost instantaneous, not significantly longer than the time during which the acoustic signal is heard where an audible signal is employed. Where the smart phone runs the authentication application in the background, the process can be hands free and effortless, however, positive acknowledgement from the user is preferred to confirm the user wants to be logged in. The process is nearly as quick where the application needs to be selected by the user, and could be as simple as selecting an icon for phones such as the iPhone™

If the verification does not succeed or times out, the web browser is instructed to display an error message to the user and to suggest further or alternative steps. A display may ask the user if his or her phone is close to the personal computer, or prompts for normal password based authentication, or the like, may be displayed.

Among the several benefits of the present invention are the following which are listed as exemplary and not intended to be an all inclusive catalog or listing thereof. There is no need for a user to remember separate passwords for individual web sites or to remember long, complex, near random passwords for enhanced security. Since the smart device has extensive computing capabilities, strong authentication mechanisms based on lengthy pseudo-random passwords and cryptography may be readily employable. The user does not have to type passwords or perform any other actions apart from having the phone present and available or selecting an authentication or verification application thereon, as the case may be. A separate connection, such as second Internet connection 132 utilized by phone 130, significantly increases the degree of difficulty for a hacker as two separate channels may need to be successfully hacked, and even then with a single session verification, any information actually hacked may be of limited value.

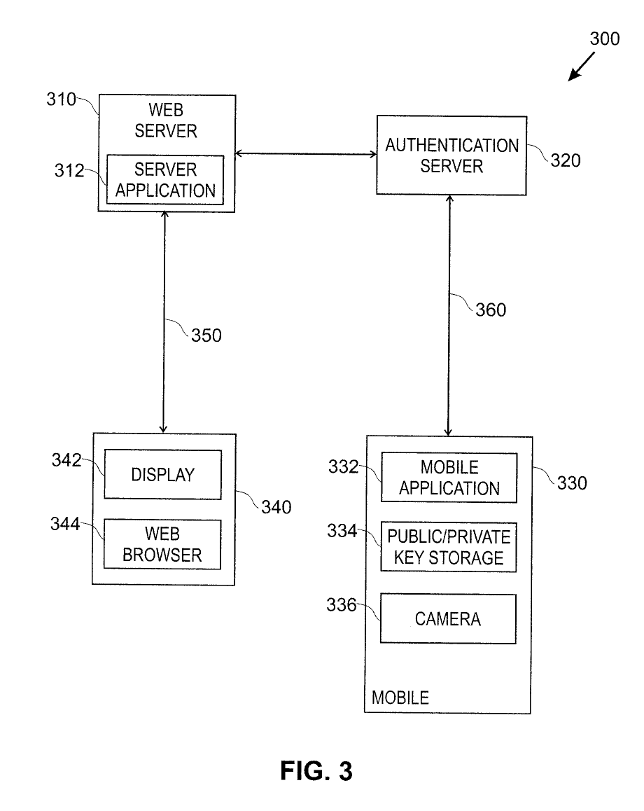

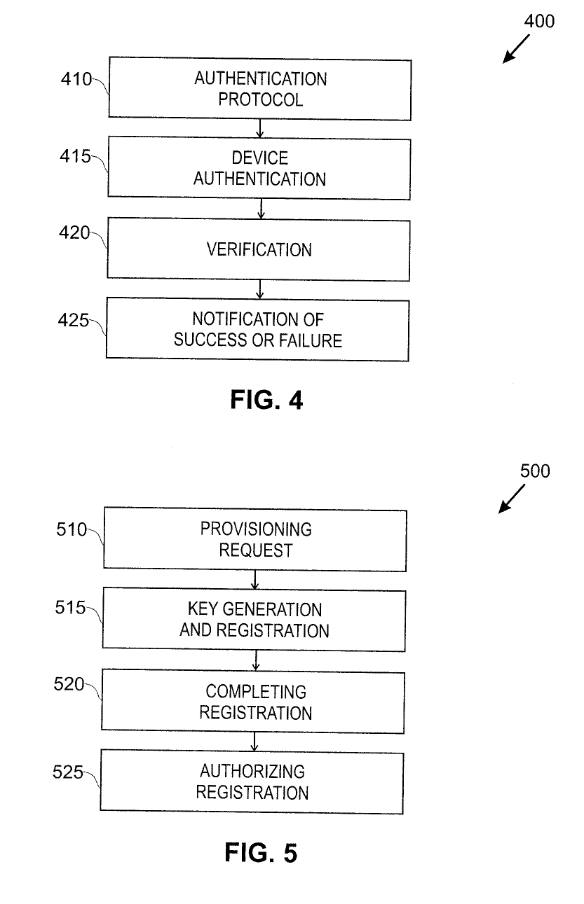

A presently preferred approach to providing an authentication mechanism in accordance with the present invention is described below in connection with FIGS. 3 and 4. FIG. 3 shows a system 300 in accordance with an embodiment of the present invention. FIG. 4 illustrates aspects of an authentication process 400 in accordance with the present invention. The approach may suitably comprise the following parts:
1. a server application, such as a web site, that has protected resources. An exemplary authentication server 320 is shown in FIG. 3. A user wanting to gain access to said resources must prove his identity to the server application through an authentication mechanism.
2. an authentication provider that is responsible for verifying the user's identity. In simple scenarios, this might be a module within the same server application, or it might be a completely separate, single sign-on system, such as an OpenID provider. An exemplary authentication server 320 is shown in FIG. 3.
3. a client application acting on behalf of the user. This client application could be a web browser, applet or a rich client working as part of a distributed application, such as web browser 344 shown in FIG. 3.
4. a mobile device owned by the user that can run custom applications and that has a camera that can be used to capture QR codes, such as the QR code 126 displayed on the display 125, for example. One example of a mobile device is mobile device 330 of FIG. 3.
5. a mobile application that will run on the user's device and will store the device/user keys securely. This mobile application will also be responsible for one end of the second authentication channel. Note that a single device/application could store multiple key pairs, one for each application the user has access to. An exemplary mobile application 332 is shown in FIG. 3.
6. a set of public/private keys. Each user and authentication device combination will have one public/private key pair, such as RSA or DSA, that uniquely identify the user to the authentication provider. For example, mobile 330 and an authentication server 320 for a user's bank will have one public/private key pair. Mobile 330 and a second authentication server 320 for a user's credit card company will have one public/private key pair, and so on. It is recommended that keys are at least 1024-bits long. An exemplary set of public/private keys 334 is shown in FIG. 3.
   This embodiment addresses an easy way for the user to carry his authentication, in other words, private/public keys, around on a device commonly used, without needing to carry a separate dedicated device. Furthermore, the proposed protocol enables a user to authenticate through a single action using a mobile device, such as the devices 130 and 330, without needing to type in usernames or passwords manually to the server application 312.

This authentication protocol provides a two-channel authentication system in which the main channel is established between the user, such as a web browser on a desktop or laptop computer, or a custom client application, and the server application/authentication provider. In FIG. 3, desktop 340 connects to server 310 and server application 312 through a main channel 350. This channel is used by the authentication provider preferably to present the authentication challenge and to deliver the authenticated session token once the user's identity has been verified. A secondary channel is setup between the user's device that stores his/her public/private keys, and the authentication provider. An example of a secondary channel is channel 360 connecting mobile 320. This channel 360 is used by the device to verify the user's identity to the authentication provider.

All messages exchanged between the application and the authentication provider preferably transfer data as a list of key-value pairs. A message will consist of a sequence of lines. Each line will start with a field name or key, followed by a colon (‘:’) and the value associated with the field. The line is terminated by a single newline character, such as UCS codepoint 10, “\n”. A key will not contain the newline or colon characters, and values will not contain any newline characters either. An example is shown below:

ID: 1233AD875

Signature: 87ad89123

If whitespace is present before or after the colon, it should be removed when extracting the key name and value from the message. Whitespace should not be added before the newline character, unless it is part of the value itself. Messages are encoded in UTF-8 to produce a byte string.

One suitable protocol 400 of FIG. 4 is described in detail below. Protocol 400 comprises protocols or operational blocks, such as an authentication protocol 410, device Authentication 415, verification 420, success/failure notifications 425, a device provisioning protocol 430, provisioning request 435, key generation and registration 440, completing registration 445, authorizing registration 450, signature algorithm 455 and public key encodings 460. All messages include a field containing the protocol version number, represented as the string “1.0”. Beginning with authentication protocol 410, the authentication protocol 410 may suitably comprise a 4-step process: (1) the authentication request, (2) device authentication response, (3) verification and (4) success/failure notification. An authentication request is presented by the authentication provider whenever the user wants to access a secured resource and the user session has not been previously authenticated or the session has expired.

The authentication provider will present the user with an authentication request containing an alphanumeric QR code with the authentication challenge through the client application. This QR code will encode a string “A|V|AN|ID|TS|NONCE”, where:
A: The request type. This will be the literal ‘A’ (for authentication).
V: The protocol version string (1.0).
AN (string): the name of the application that is requesting the authentication.
ID (string): A unique request ID that identifies this authentication request in a unique manner. It is recommended that request IDs are globally unique or as random as possible so that they are not easy to guess.
TS: A time stamp, in the format yyyyMMddHHmmss in UTC. This should be the date/time when the authentication process started.
NONCE: The random authentication challenge token, consisting of a 30-byte block computed using a cryptographic random number generator and encoded in Hex-format.
   The ‘|’ (ASCII character 0x7C) is used as a separator in the encoded string and cannot be present in any of the fields.

Once the authentication request is generated, the user will start the application on his mobile device and use device authentication 415 protocol to verify his/her identity with the authentication provider:
1. The application uses the camera built into the device, such as camera 136 of device 130 or camera 336 of device 330, to capture the QR Code presented during the authentication request and decodes the information contained in it.
2. The application uses the value of the application name (AN) field to locate a key pair in the internal store that has been registered for authentication with the specific application. Note: A device/application can also secure the private key with a password for extra security. In this case, the user will need to unlock the private key using his/her secret password before continuing.
3. The application will compose the string “DID| UN|AC”, where:”
   DID is a “unique” device id that identifies this device, for example the IMEI for GSM devices.
   UN is the username stored alongside the key pair for use with the specified server application.
   AC is the original string encoded in the QR Code (“A|V|AN|ID|TS|NONCE”)
4. The application will convert “DID| UN|AC” to bytes using the UTF-8 encoding, and calculate a binary signature S using the selected private key.
5. The application will compose a secure HTTPS POST request to the predefined authentication endpoint stored alongside the keys for this server application/authentication provider. The body of this request will contain the following list of fields, formatted using the rules described in the message encoding discussion:
   Version: The protocol version string, as specified in the authentication request.
   ID: The unique id assigned to the authentication request (extracted from the ID field of the authentication request).
   TS: The time stamp, in the format yyyyMMddHHmmss in UTC, as specified in the authentication request.
   DID: The unique device id.
   User: The username to authenticate
   Signature: The value of the computed signature S, encoded in Base64.
A sample body of an HTTP request might look like this:
Version: 1.0
ID: b23412c2-74d5-4f28-9bcd-bdc8d1b9b039
TS: 20101201145241
DID: 356848014686602
User: myuser
Signature: Cf2JrXuJcSNEPaic25gJhQEorXRUX9CfzHUOIUM=
Extra fields can be included in the request body, if desirable, or if required by specific implementations. For example, a device could include a picture taken with the device front-facing camera, capturing an image of the face of the user making the request in the process, as base64-encoded data, for auditing purposes.
6. The application should receive a reply from the authentication server to the request. If the request succeeds, a 200 OK response should be expected.

Next, verification process 420 is performed by the authentication provider when it receives the HTTP POST request sent by the device. To verify the user's identity, the authentication provider will:
1. Use the value of the ID header to find out the information included in the original authentication request, including the application name AN, time stamp TS, and the NONCE.
2. Verify that the value for the TS field in the HTTP request matches the value stored by the server.
3. Verify that the authentication request has not already expired. This verification is done by comparing the time stamp TS with the current date/time and ensuring that less than a predetermined time, X, has passed. It is recommended that the authentication window be a small value, such as 5 minutes, for example, in order to minimize the possibility of replay attacks.
4. Find out the last time that the device, using the DID field, was used for authentication/provisioning and the timestamp (TS) value was used, and verify that the TS value included in this request is strictly newer than the stored one. This constraint also reduces the risk of replay attacks using captured information.
5. Store the device id (DID) and timestamp (TS) in persistent storage, so that it can be used for verification in further authentication attempts.
6. Locate the public key associated with the username UN on its internal user database. Verify that the key is still currently marked as valid and has not been revoked, for example, if the device was reported lost or stolen). It should also verify that the Device ID (DID) in the request matches the provisioned device.
7. Compute the string “DID|UN|A|V|AN|ID|TS|NONCE”, encode it in binary using UTF-8 encoding and verify the signature presented in the signature field over it.
8. If the signature matches, the authentication provider will consider the session authenticated.

Once the verification process 420 has been completed, or the server considers the authentication request expired without receiving an authentication response from the device, the authentication process will send the status of the request to the client to provide notification of success or failure 425. Two approaches to provide such notification are as follows:
Async Model: The client will get the unique request ID, which it can use to poll the server application for the status of the pending request. This pulling will require extra work on the client side as well as multiple network round trips, but might be preferable in many cases.
Sync Model: The client will go back to the server only once and wait until the authentication provider responds with the result of the authentication request, holding a single live connection opened during that time. This approach will require a single network round trip, but will mean extra resources will be tied up on the server side.
   If the user's identity was successfully verified, the authentication provider will mark the session as authenticated and redirect the user to the secured resource.

Prior to the first time that authentication process 400 is employed in conjunction with a specific authentication provider, a trust relationship must be established between the device and the authentication provider. A device provisioning process 500 is one example of how to establish this relationship. Process 500 is used to generate a new set of keys for a device/user for the specific server application/authentication provider, and register the new public key with the authentication provider. The exemplary device provisioning process 500 of FIG. 5 consists of four steps: (1) the provisioning request 510, (2) generating and registering the new keys 515, (3) completing the registration 520, and (4) authorizing the registration 525. The mechanics employed are similar to the regular authentication protocol. In one approach, there would be a witness present during the provisioning process that could verify the user's identity through other means, like examining a government-issued photo ID, and the device that will be provisioned. For example, if the authentication protocol was to be used for an online banking application, the bank could require that the provisioning process be performed in person at a local branch office in front of an officer of the bank.

The provisioning request 510 may suitably comprise an alphanumeric QR Code that encodes the string “P|V|UN|AN|ID|TS|NONCE|PURL”, where:
P: The request type. This will be the literal ‘P’ (for provisioning).
V: The protocol version string (1.0).
UN (string): The username assigned by the application/authentication provider to the person that is going to provision a new device.
AN (string): the name of the application the device will be provisioned for.
ID (string): A unique request ID that identifies this provisioning request in a unique manner. It is recommended that request IDs are as random as possible so that they are not easy to guess. A UUID would be a good match here.
TS: A time stamp, in the format yyyyMMddHHmmss in UTC. This should be the date/time when this provisioning process started.
NONCE: The random provisioning challenge token, consisting of a 30-byte block of bytes computed using a cryptographic random number generator and encoded in Hex-format.
PURL: The Provisioning URL for this application, which is optional. If PURL is missing, the device should assume a value of “https://www.com/provision?app=AN”, where ‘AN’ is the URL-encoded representation of the Application Name (AN) field.

After the application on the user's device has scanned the QR code with the provisioning request and decoded it, key generation and registration 515 is employed to generate a new public/private key pair for the authentication. The choice of RSA/DSA keys is left to the user/application. The application should verify that both the provisioning and authentication URLS (PURL/AURL) specify the use of secure channels (HTTPS) for SSL/TLS.

Once the new key pair is generated, the application 500 will:
1. Store the private and public keys, the application name AN, the assigned username UN, and the application's authentication URL (AURL).
2. Compose the string “DID| PC|PK”, where:
   DID is a “unique” device id that identifies this device, for example the IMEI for GSM devices.
   PC is the provisioning challenge as decoded from the QR Code
   PK is the hex-encoded representation of the generated public key.
3. Compute the signature PS over the string “DID| PC|PK” using the private key.
4. Send a secure HTTPS POST request to the URL specified by the PURL field. Like in the authentication protocol, the body of this request will use the message encoding rules defined elsewhere in this document, and will advantageously contain the following fields:
   Version: The protocol version string, as included in the provisioning request.
   ID: The unique id assigned to the provisioning request (extracted from the ID field of the provisioning request).
   TS: The request timestamp, in the format yyyyMMddHHmmss in UTC. This must be the same value found in the authentication request.
   DID: The unique device id.
   User: The username UN.
   KeyAlgorithm: The key algorithm selected by the client. Can be either “rsa” or “dss”.
   PublicKey: The generated public key, encoded using Base64.
   Signature: The value of the computed signature PS, encoded as a string using Base 64.

Completing registration 520 is done by the authentication provider when it receives the HTTP POST request sent by the device. To complete the provisioning process, the authentication provider will:
1. Use the value of the ID field to find out the information included in the original provisioning request, including the application name AN, time stamp TS, username UN, and NONCE.
2. Verify that the value for the TS field in the HTTP request matches the value stored by the server.
3. Verify that the provisioning request has not already expired. This verification is performed by comparing the time stamp TS with the current date/time and ensuring that less than a predetermined time, X, has passed. How long it takes for requests to expire will depend on how the provisioning process is implemented. For example, in the in-person scenario described earlier, requests could expire after 5 or 10 minutes.
4. Compute the string “DID| P|V|UN| AN|ID|TS|NONCE|PK”, and encode it to binary using UTF-8 encoding and verify the signature presented in the Signature over it, using the public key included in the request, and the key algorithm specified by the KeyAlgorithm field.
5. If the signature matches, the authentication provider will consider the device registered. It will write the following information to its persistent store:
   The public key and key algorithm, the device ID (DID) and request timestamp (TS). These should be associated with the username (UN).
   A reasonably unique confirmation code (CC) generated by the system. This confirmation code could be a transaction identifier.
6. The provisioning endpoint will reply with an HTTP “2000K” status. The body of the request will contain the following fields:
   Version: The protocol version string.
   ID: The authentication request ID.
   CC: the confirmation code generated by the server.
   AURL: The authentication URL the device should use when sending authentication requests for this application on behalf of the user.
The device should store the AURL value alongside the key set, username and application name.
   At this point, the device will be registered, but the authentication provider preferably blocks the device from being used for authentication until the following step is completed by the user to close the provisioning loop.

To further ensure that the device registration was done by the user, an authorizing registration step 525 is employed. To this end, the confirmation code generated by the authentication provider is fed back to the authentication provider through another channel. This process is similar to the process used for a credit card that has been issued, but has not been activated by the cardholder.

Only after the authentication provider has received and verified the confirmation code, should it consider the device fully provisioned and ready to be used in the authentication process. For example, in the banking scenario described above, this could be accomplished by the user reading the confirmation code from his device and handing it over to the bank officer, who would in turn enter that code into an application on a banking terminal to submit it to the authentication provider. In another scenario, this step could be accomplished by the user dialing a system, interactive voice response (IVR), and entering the confirmation code through the phone as is typically done to activate a credit card today. While an exemplary approach is described above, other approaches may be employed.

The above specified authentication process 400 has some properties that make it an interesting option to more traditional authentication systems used on the web. First, its use helps prevent phishing attacks. Because the proposed authentication protocol uses a secondary channel for authentication through the mobile device, and the URL of the authentication endpoint is already known by the authentication device and cannot be overridden by a rogue web page, the protocol would be much less susceptible to phishing attacks. Second, its use helps prevent key loggers as the authentication protocol does not require the user to type any part of his or her credentials on a form on the web page requesting authentication. The entire process may be done employing a mobile device which is more likely to be closely supervised and controlled by the user. As a result, a key logger on a public or other PC or laptop that the user was utilizing would not be able to capture any part of the authentication credentials. Third, the user's credentials are portable. Because the user credentials, for example, username and private keys, are stored on the mobile device, the user can logon securely to the server applications anywhere, regardless of what desktop or laptop computer is being used to access the application. Fourth, key management is provided as user keys/devices can be revoked and verified by the authentication provider, which makes it easy to deal with lost or stolen devices or units compromised for the user, and secure for the application. Fifth, the authentication process is completed with a simple click to start the application on the device. No other typing or clicking is required from the user.

The Table below summaries how aspects of the present invention counteract to mitigate a variety of potential attack vectors.

| Attack Vector | Mitigation |
|---|---|
| Communications between user | All communication between the user |
| agent and authentication provider | agent/device and the |
| or between the device | authentication provider |
| and the authentication | should be done using a |
| provider could be inter- | secure protocol that |
| cepted and used to | provides full encryption, |
| hijack the provisioning | like SSL/TLS. |
| or authentication processes. | |
| Unique IDs generated by | Any unique ID generated should be |
| the authentication provider for | very random and with as small as |
| provisioning or authentication | possible chance |
| requests could be guessed | of collision. Something like a UUID |
| by a third party and used to | or a larger random number generated |
| hijack the processes. | with a strong cryptographic RNG |
| | would be a good source here. |
| Replay attacks could be used | The window during |
| to either overwrite a provisioning | which a message could |
| on the authentication provider | be replayed is shrunk by ensuring |
| or to obtain a secondary | that the authentication provider |
| authentication token/cookie | verifies that only a |
| during authentication | predetermined amount of time, X, |
| if a malicious agent somehow | has passed since the authentication/ |
| gains access to the raw | provisioning process was started |
| data sent between the device | by the user. |
| and the authentication provider. | |
| | For example, the authentication |
| | provider can check that |
| | when the device attempts to verify |
| | the user identity, less |
| | than 5 minutes have |
| | passed since the original QR |
| | code was generated by the |
| | authentication provider, |
| | and raise an error if this is not the case. |
| | Also, the use of the request timestamp |
| | (TS) helps mitigate this issue, |
| | because the |
| | authentication provider verifies the |
| | timestamp in the message is |
| | newer than the last |
| | one used during the last authentication. |
| The keys stored on the device | A way to revoke existing keys |
| could be compromised | may advantageously be supported |
| or the device itself | by the authentication |
| could be stolen/lost. | provider. If this happens, |
| | the user must go through the |
| | provisioning process again to gen- |
| | erate a new pair of keys. |
| | During any authentication attempt, |
| | the authentication provider |
| | should ensure |
| | that the selected key pair is still valid |
| | and has not been revoked. |

While the present invention has been disclosed in the context of a presently preferred embodiment, it will be recognized that a wide variety of changes or variations may be made consistent with the teachings herein and the claims which follow. By way of example, while an acoustic link between the personal computer 120 and smart phone 130 and a QR code and camera link are shown and discussed as perhaps being the simplest from the point of view of many potential users, it will be recognized that other links could also be employed. For example, other links such as infrared, Bluetooth™, a local wireless link, Wi-Fi, or a USB connector may also be employed as desired.

If the personal computer speakers and the microphone of the smart phone support such operation, the acoustic signal may be inaudible to the human ear. Such operation has the advantage in a public environment, such as use of a library or airport computer, of not disturbing other people in the vicinity.

The personal computer or other browser device can be any other suitable device such as a laptop, a vending machine, or the like through which a secure login might be required as part of a transaction. With a vending machine, the end result will be the authorization of a purchase and vending the purchased item, for example.

Instead of the Internet connections shown other communication channels or some combination thereof may be employed. For example, SMS, email, or touchtone over a standard telephone connection or the like may be employed for one or more of the connections.

To reduce the possibility of someone stealing or finding a legitimate user's smart phone, the user may be further required to authenticate himself or herself to the smart phone 130 or user device 330 before beginning the process to provide a further level of security if desired or required by or for certain users and application contexts. By way of example, U.S. Patent Application Publication Nos. 2009/0083847 and 2009/0083850 describe a wide array of suitable user authentication approaches, such as voice recognition, visual recognition, fingerprint recognition or other biometric evaluations which may be utilized alone or in combination to authenticate the user as to the legitimate owner and user of the smart phone 130. Both of the above identified published applications are incorporated herein in their entirety by reference. As one example, the user may be requested to speak a unique id displayed by the browser on the display 125 or to enter a PIN or password before proceeding.

Other security processes other than a digital certificate may be employed, such as hashing with a shared password.

While a separate authentication server 140 or 320 is shown in FIGS. 1 and 3, respectively, it will be recognized that authentication process may be integrated into a single server, such as the web server 110 or 320.

I claim:

1. A user verification method comprising:
beginning a log in process for a user to utilize a web site by employing a first device to communicate with a web server having an address on a first channel and hosting the web site;
providing a signal from the first device to a second device which is portable;
evaluating the signal from the first device by the second portable device;
communicating the address of the web server and authentication information for the user on a second channel by the second portable device; and
authorizing the user to conduct a session with the web site.

2. The method of claim 1 wherein the signal is an encoded acoustic signal and the second device is a smart phone which evaluates the encoded acoustic signal by decoding the encoded acoustic signal.

3. The method of claim 2 wherein the smart phone receives the encoded acoustic signal utilizing a microphone used for making a voice call.

4. The method of claim 1 wherein the first and second channel are separate Internet connections.

5. The method of claim 1 wherein the address of the web server and the authentication information for the user are communicated to an authentication server.

6. The method of claim 5 wherein the authentication server performs authentication of the user and communicates an authentication confirmation to the web server.

7. The method of claim 1 further comprising the step of executing an authentication application on the second portable device in response to selection of an icon.

8. The method of claim 1 wherein the second device is a smart phone.

9. The method of claim 8 further comprising the step of;
authenticating a user of the smart phone utilizing a recognition application on the smart phone prior to beginning the log in process.

10. The method of claim 8 wherein said step of providing comprises displaying a visual output on a display of the first device and the step of evaluating begins with capturing the visual output utilizing a camera in the second device.

11. The method of claim 10 wherein the visual output comprises a text, a bar code, an image or a time sequence thereof.

12. The method of claim 1 wherein the first device comprises a personal computer, laptop computer, a public kiosk or a computer contained within an online vending machine.

13. The method of claim 1 wherein the second device signs the address of the web server and the authentication information for the user using a digital certificate before the step of communicating.

14. The method of claim 1 wherein the second device employs encryption.

15. The method of claim 1 wherein the signal is an optical display of a QR code.

16. The method of claim 15 wherein evaluating the signal comprises reading the QR code with a camera and decoding the QR code.

17. An authentication server comprising:
memory storing a public and private key pair uniquely identifying a mobile device of a user to the authentication server;
a first input connection to a first channel for communicating with the mobile device of the user;
a second input connection to a second channel for communicating with a second device employed by the user to access a server application; and
a software application executed by a processor to recognize the public and private key pair received from the mobile device utilizing the first input connection; the software application further receiving a unique session identifier on the second input connection and comparing the unique session identifier with a session identifier received on the first input connection from the mobile device.

18. The authentication server of claim 17 wherein the session identifier received on the first input connection is derived from an optical code.

19. The authentication server of claim 18 wherein the optical code is a QR code.

20. The authentication server of claim 19 wherein the software application generates the session identifier which is transmitted encoded as the QR code over the second channel to the second device.
